(19) United States
(12) Patent Application Publication
(10) Pub. No.: US 2007/0115192 A1
(43) Pub. Date: May 24, 2007

(54) Key fob having LF single dimension tranceive antenna and two-dimension receive antenna

(75) Inventor: Richard P. Brandwein JR., Villa Park, IL (US)

Correspondence Address: FOLEY AND LARDNER LLP;SUITE 500, 3000 K STREET NW, WASHINGTON, DC, 20007, US

(73) Assignee: OMRON AUTOMOTIVE ELECTRONICS, INC.

(21) Appl. No.: 11/599,254

(22) Filed: Nov. 15, 2006

Related U.S. Application Data
(60) Provisional application No. 60/737,806, filed on Nov. 18, 2005.

(51) Int. Cl. H01Q 1/32

(52) U.S. Cl. 343/713; 340/5.61; 343/893

(57) ABSTRACT

A key fob includes a 1-D antenna that provides for transmission and reception of signals on a first axis. The key fob also includes a 2-D antenna that provides for receipt of signals of a second axis and a third axis, wherein the first, second and third axes are orthogonal to each other. The 1-D antenna and the 2-D antenna are provided on a printed circuit board disposed within a housing of the key fob.

This application claims priority to U.S. provisional patent application 60/737,806, entitled “LF Transceiver With Multiple Dimension Antenna”, filed Nov. 18, 2005, which is incorporated in its entirety herein by reference.

### FIELD OF THE INVENTION

The invention relates to an antenna assembly. More specifically, the invention relates to an antenna assembly for a key fob that includes a single-dimension transceiver antenna and a two-dimension receive antenna.

### BACKGROUND OF THE INVENTION

Keyless entry devices are ubiquitous, especially in the vehicle field. Typically, a user has a key fob, in which the fob provides a housing for a printed circuit board that allows for various functions, such as door lock, door unlock, vehicle immobilization, and truck/hood/latch lock/unlock.

One such conventional key fob is a Philips' PCF7952 device, which can be used with a three-dimensional (3-D) antenna for transmitting and receiving low frequency (LF) signals to/from a base station. For vehicular applications, the base station corresponds to a transmitter/receiver provided at a known location on the vehicle. The base station transmits LF signals that are received by the key fob using the 3-D antenna which may be provided on a printed circuit board provided within the key fob, and the base station receives LF signals that are transmitted by the key fob using the 3-D antenna. FIG. 5 shows a 3-D antenna provided within a conventional key fob. FIG. 4 shows three separate 1-D antennas provided within a conventional key fob, which has the same capabilities as a single 3-D key fob. In either instance, much printed circuit board space is required.

U.S. Patent Nos. 6,563,474 and 6,940,461 describe remote access devices having multiple inductive coil antennas, which are typical antenna used for key fob applications. FIG. 1 shows multiple inductors 10′, 20′, 30′wound around a single form, in order to provide a coil 3-D antenna 100. FIG. 2 shows a different construction of multiple inductors 10, 20, 30 wound around a single form 40, in order to provide a 3-D coil antenna 200.

Japanese laid open patent application 2005-124013 describes an antenna used for keyless entry systems, in which the antenna is a 3-D antenna that is used to receive signals from a base station (e.g., a vehicle). Japanese laid open patent application 2003-249816 describes an antenna used for keyless entry systems, in which a 2-axis coil is wrapped around one core to provide a 2-D antenna, and in which a 1-axis coil is wrapped around another core to provide a 1-D antenna.

The inventor of this application has determined that the use of 3-D antennas for key fobs has several disadvantages, namely inflexibility and high cost.

There is a need to provide a key fob that provides for similar features as a conventional key fob having a 3-D antenna, or a conventional key fob having three separate 1-D antennas, or a conventional key for having a 1-D antenna and a 2-D antenna that have both transmit and receive capabilities, but that is more flexible and of lesser cost to construct.

### SUMMARY OF THE INVENTION

An aspect of the present invention relates to a key fob. The key fob includes a 1 -D antenna that provides for transmission and reception of signals on a first axis. The key fob also includes a 2-D antenna that provides for reception of signals of a second axis and a third axis, wherein the first, second and third axes are orthogonal to each other. The 1-D antenna and the 2-D antenna are provided on a printed circuit board disposed within a housing of the key fob.

Another aspect of the invention relates to a key fob. The key fob includes a housing; a first printed circuit board disposed within the housing; and a second printed circuit board disposed within the housing. The key fob also includes a 1-D antenna that provides for transmission and reception of signals on a first axis; and a 2-D antenna that provides for receipt of signals of a second axis and a third axis. The first, second and third axes are orthogonal to each other. The 1-D antenna and the 2-D antenna are respectively provided on the first and second printed circuit boards.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a perspective view of a conventional 3-D coil antenna.

FIG. 2 is a perspective view of another conventional 3-D coil antenna.

FIG. 3 is a perspective view of a 2-D coil antenna utilized in a key fob according to a first embodiment of the invention.

FIG. 4 is a diagram showing the disposition of three separate 1-D antennas within a key fob according to a conventional implementation.

FIG. 5 a diagram showing the disposition of a single 3-D antenna within a key fob according to a conventional implementation.

FIG. 6 is diagram showing a disposition of a single 2-D antenna and a single 1-D antenna within a key fob according to a first embodiment.

FIG. 7 is diagram showing another disposition of a single 2-D antenna and a single 1-D antenna within a different type of key fob according to the first embodiment.

FIG. 8 is block diagram showing components provided on a printed circuit board of a key fob according to the first embodiment.

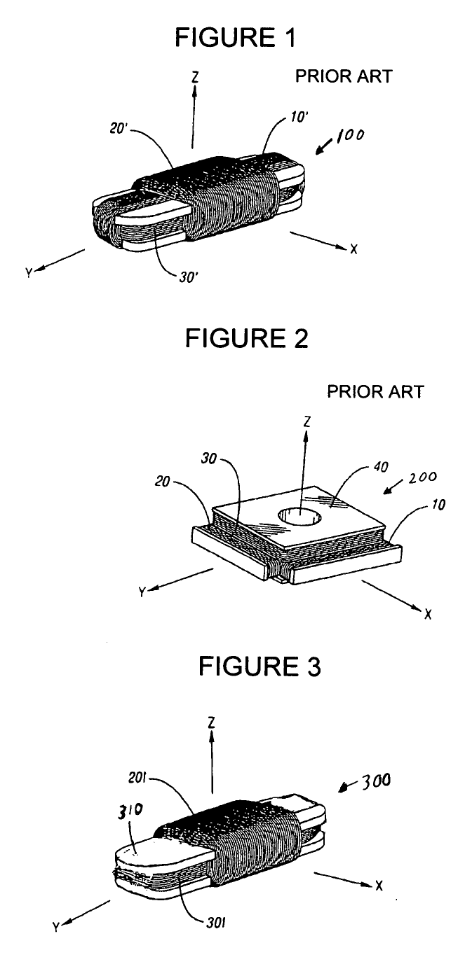

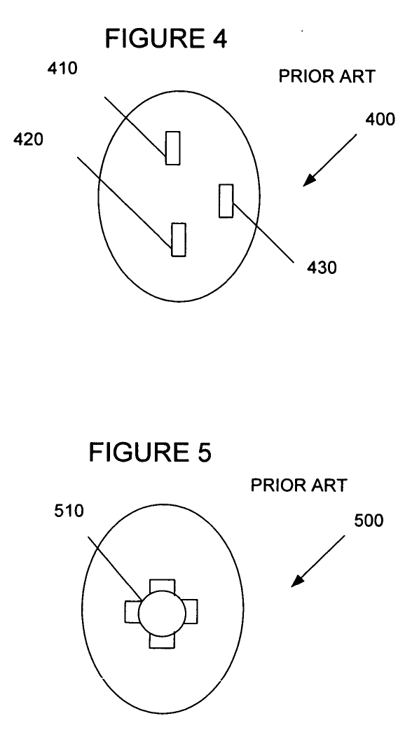

### DETAILED DESCRIPTION

Reference will now be made in detail to embodiments of the invention, examples of which are illustrated in the accompanying drawings. An effort has been made to use the same reference numbers throughout the drawings to refer to the same or like parts.

A first embodiment of the invention is directed to a key fob for use in operating a vehicle or other type of device (e.g., a motorcycle, a boat, a house). The key fob has an exterior housing, such as plastic housing. Within the plastic housing is provided a printed circuit board (PCB), on which various components known to those skilled in the art are provided. Such components include a memory chip, a processor, and signal processing circuitry.

Upon activation of a particular button on the exterior housing of the key fob, the processor outputs a signal that is sent to the vehicle by way of an antenna. In the conventional key fob described earlier, this signal is a LF signal that is output by way of a 3-D antenna, and received by a base station provided within the device-to-be-controlled (e.g., a vehicle). However, in the first embodiment, the signal is an LF signal that is output by way of a 1-D antenna. For the conventional key fob having a 3-D antenna, signals output from the vehicle base station are received by the 3-D antenna. For the key fob according to the first embodiment, depending upon the orientation of the signal output by the vehicle base station, the signal is received by either the 2-D antenna or by the 1-D antenna, and then provided to the signal processing circuitry of the key fob.

Because a 3-D antenna takes up much room on a PCB, and since separate 1-D antennas for the three axes (X, Y, Z) also take up much room on a PCB, the present invention has been developed to provide a key fob that has antenna functions that take up less room than the antenna functions of conventional key fobs, but that provides virtually the same transmit and receive capabilities.

In a first implementation of the first embodiment, as seen in FIG. 3, a 2-D antenna 300 is provided on a PCB located within a housing of a key fob. The 2-D antenna is shown as combining the Y and Z axes, and thereby being configured to receive signals along the Y or Z axes. In particular, a coil 201 is wound around a single form (or substrate) 310 along the Y axis, and a coil 301 is wound around the single form 310 along the Z axis. In this application, the X and Y axes correspond to the axes on which the PCB (on which the substrate is disposed) of the key fob is located (e.g., length and width of the key fob), and the Z axis corresponds to an axis defining a height of the key fob. In the first embodiment, a separate 1-D antenna is also provided on the PCB, whereby this separate antenna corresponds to an X-axis antenna in the first implementation of the first embodiment. 1-D antenna construction is known to those skilled in the art, and will not be described in detail herein below. The 1-D antenna is capable of both LF signal transmission and reception on the X-axis, while the 2-D antenna is only capable of LF signal reception on the Y-axis or Z-axis. The X, Y and Z axes collectively form a three-axis coordinate system.

Since the base station provided in the vehicle is specifically located (that is, it is located where the vehicle is positioned), the inventor of this application has determined that the use of a 3-D antenna in the key fob does not provide any meritorious benefits over a 1-D antenna, since the key fob operator will know to point the key fob in a precise position where the vehicle is located in order to have the vehicle perform a keyless operation (e.g., open door, open trunk, lock doors). As such, a smaller sized and less costly key fob than what is used in conventional systems is obtained with virtually the same usefulness.

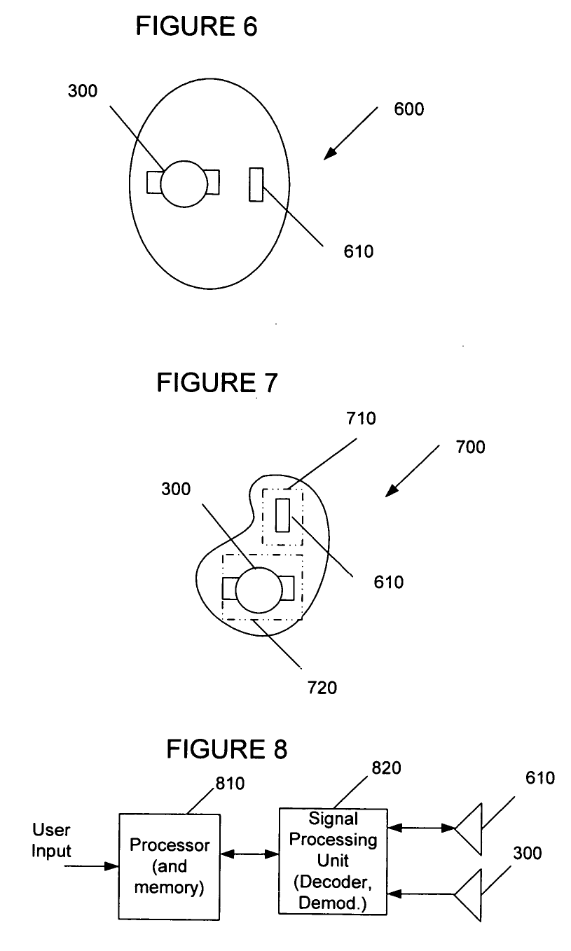

FIG. 6 shows a disposition of a single 2-D antenna 300 and a single 1-D antenna 610 within the housing (not shown ) of a key fob 600 according to the first embodiment, whereby the single 2-D antenna 300 receives signals on the X axis or the Z axis, and whereby the single 1-D antenna 610 receives signals on the Y axis and transmits signals (to the vehicle base station) on the Y axis. Since a 2-D antenna 300 takes up less space than a 3-D antenna, and is less costlier to manufacture, the total size taken up by the single 2-D antenna 300 and the single 1-D antenna 610 is less than the total size taken up by either: a) a single 3-D antenna, or b) three separate 1-D antennas, and is less costlier to manufacture than either of these conventional approaches.

In a second implementation of the first embodiment, the 2-D receive antenna combines the X and Y axes, whereby the 1-D receive and transmit antenna is provided for the Z axis. in a third implementation of the first embodiment, the 2-D receive antenna combines the Y and Z axes, whereby the 1-D receive and transmit antenna is provided for the X axis.

In a third implementation of the first embodiment, signals received by both the 1-D antenna and the 2-D antenna are combined by a diversity combiner, using known diversity combining techniques, in order to optimize reception of a signal output from a base station. Such diversity reception may be performed by a signal processing unit 820 as shown in FIG. 8, in order to optimize the reception capabilities of the key fob according to the first embodiment.

The key fob according to the first embodiment can be used for passive function devices, in which some amount of LF transmission is required from the fob to perform a particular function, such as a vehicle immobilizer function. The 1-D receive/transmit antenna provides for this LF transmission. For example, in a case whereby a vehicle base station outputs an LF signal that is received by a key fob held by a user standing nearby the vehicle, the received LF signal is capable of generating enough current in the key fob to operate the key fob and cause it to return a signal to the vehicle base station to notify the vehicle base station of the proximity of the user to the vehicle. For example, this notification may cause the vehicle to turn on an air conditioner or heater function, depending on the detected outside air temperature, in order to set up the vehicle for the user in an expeditious manner before the user even enters the vehicle. This key fob operation based on reception of a signal output by a vehicle base station is referred to as “batteryless operation”.

As explained above, key fobs are typically small in size, and thus the room for a PCB within the key fob is small to begin with. Having a 2-D antenna and 1-D antenna instead of having a 3-D antenna or three separate 1-D antennas provides for more PCB space, which may be used to provide for a smaller key fob or may be used to provide for more signal processing capabilities due to the extra PCB space that is available. Also, the small size of a 1-D antenna allows for flexibility in design, in that the 1-D antenna can be provided virtually anywhere on the PCB, such as shown in FIG. 7, whereby the 1-D antenna can be fitted in a small region of that key fob (that could not accommodate a 3-D antenna ortwo 1-D antennas). In FIG. 7, the 1-D antenna 610 is provided on a daughterboard 710 positioned in a thin-width region of the key fob 700, while the 2-D antenna 300 is provided on a motherboard 720 positioned in a large-width region of the key fob 700. Not shown in FIG. 6 is the wire connectivity between the motherboard 720 and the daughterboard 710, to thereby provide connectivity between components on those two separate PCBs.

Referring now to FIG. 7 and FIG. 8, in one possible implementation of the first embodiment, a signal processing unit 820 a processor (and memory) 810, and the 2-D antenna 300 may be provided on the motherboard 720, while the 1-D antenna may be provided on the daughterboard 710. In another possible implementation of the first embodiment as shown in FIG. 6, all of the components shown in FIG. 8 are provided on a single PCB provided within the housing of the key fob 600. A two-way communicative connection is provided between the 1-D transmit/receive antenna and the signal processing unit 820, while only a one-way communicative connection is provided between the 2-D receive-only antenna and the signal processing unit 820.

One conventional way to make a 3-D antenna from a 2-D antenna is to construct a multi-layer PCB, in which the mutli-layers span the Z-axis. However, such a construction provides for a thick and bulky key fob, and is costlier as well. The first embodiment eliminates the requirement of a 3-D antenna, and thus makes for a slimmer and less costly key fob as compared to conventional approaches.

Also, since 1-D Z-axis antennas take up a relatively large footprint on a PCB, as compared to 1-D X-axis or 1-D Y-axis antennas, by providing the 1-D Z-axis antenna with one more axis of wire wrap, be it the X-axis or the Y-axis, a 2-D antenna can be obtained for virtually the same PCB footprint as would be needed for a single 1-D Z-axis antenna. Thus, the first embodiment is better in terms of cost and PCB footprint requirement as compared to a conventional key fob having three separate 1-D antennas (one for each of the X, Y and Z axes).

The 2-D antenna can be built around a common core, such as one made of a ferrite material or a plastic material. Such a construction for a 2-D inductive coil antenna is relatively low cost and takes up a relatively small PCB space.

In a second embodiment, based on the reception signal strength of a first signal received by the 1-D antenna and the reception signal strength of a second signal received by the 2-D antenna, the signal processing unit 820 of FIG. 8 can adjust the characteristics of the 2-D antenna, in order to improve the receive characteristics of that antenna. For example, assuming that the first signal received by the 1-D antenna that receives signals on the Y axis has a receive signal strength of 8 dBm, and that the second signal received by the 2-D antenna that receives signals on the X and Z axes has a received signal strength of 4 dBm, the signal processing unit 820 can control the amount of current provided to the coil wrapped around the form (or core) along X axis and the amount of current provided to the coil wrapped around the form along the Z axis such that the 2-D antenna can be tuned to cover a portion of the Y axis, since the larger signal strength of the signal received by the 1-D antenna indicates that the signals output by the base station have a Y axis component. This change in receive characteristics of the 2-D antenna can result in up to a 20 degrees receive beam change along an X, Y or Z axis, depending upon the amount of current and the difference in current provided to the two coils wrapped around the form along the two axes of the 2-D antenna. If the received signal strength is larger for 2-D antenna than the 1-D antenna, than the receive characteristics of the 2-D antenna are not changed.

The embodiments described above have been set forth herein for the purpose of illustration. This description, however, should not be deemed to be a limitation on the scope of the invention. Various modifications, adaptations, and alternatives may occur to one skilled in the art without departing from the claimed inventive concept. The spirit and scope of the invention are indicated by the following claims.

What is claimed is:

1. A key fob, comprising:
a housing;
a printed circuit board disposed within the housing;
a 1-D antenna that provides for transmission and reception of signals on a first axis; and
a 2-D antenna that provides for reception of signals of a second axis and a third axis,
wherein the first, second and third axes are orthogonal to each other, and
wherein the 1-D antenna and the 2-D antenna are provided on the printed circuit board.

2. The key fob according to claim 1, wherein the 1-D antenna is an X-axis antenna, and the 2-D antenna is a Y-Z axis antenna.

3. The key fob according to claim 1, wherein the 1-D antenna is a Y-axis antenna, and the 2-D antenna is a X-Z axis antenna.

4. The key fob according to claim 1, wherein the 1-D antenna is a Z-axis antenna, and the 2-D antenna is an X-Y axis antenna.

5. The key fob according to claim 1, wherein the 2-D antenna is a multiple inductive coil antenna.

6. The key fob according to claim 1, further comprising:
a diversity combining unit that combines signals received from the 1-D antenna and the 2-D antenna, and that provides a combined reception signal as a result thereof.

7. The key fob according to claim 1, further comprising:
an antenna characteristic changing unit that changes the receive characteristics of the 2-D antenna based on strength of first and second signals respectively received by the 1-D and antenna and the 2-D antenna.

8. A key fob, comprising:
a housing;
a first printed circuit board disposed within the housing;
a second printed circuit board disposed within the housing;
a 1-D antenna that provides for transmission and reception of signals on a first axis; and
a 2-D antenna that provides for receipt of signals of a second axis and a third axis,
wherein the first, second and third axes are orthogonal to each other, and
wherein the 1-D antenna and the 2-D antenna are respectively provided on the first and second printed circuit boards.

9. The key fob according to claim 8, wherein the 1-D antenna is an X-axis antenna, and the 2-D antenna is a Y-Z axis antenna.

10. The key fob according to claim 8, wherein the 1-D antenna is a Y-axis antenna, and the 2-D antenna is a X-Z axis antenna.

11. The key fob according to claim 8, wherein the 1-D antenna is a Z-axis antenna, and the 2-D antenna is an X-Y axis antenna.

12. The key fob according to claim 8, wherein the 2-D antenna is a multiple inductive coil antenna.

13. The key fob according to claim 8, wherein the first printed board is a motherboard, and wherein the second printed circuit board is a daughterboard.

14. The key fob according to claim 8, further comprising:
a diversity combining unit that combines signals received from the 1-D antenna and the 2-D antenna, and that provides a combined reception signal as a result thereof.

15. The key fob according to claim 8, further comprising:
an antenna characteristic changing unit that changes the receive characteristics of the 2-D antenna based on strength of first and second signals respectively received by the 1-D and antenna and the 2-D antenna.

16. A key fob, comprising:
a housing;
a printed circuit board disposed within the housing;
first antenna means that provides for transmission and reception of signals on a first axis; and
second antenna means that provides for receipt of signals of a second axis and a third axis,
wherein the first, second and third axes are orthogonal to each other, and
wherein at least one of the first and second antenna means is provided on the printed circuit board.

17. The key fob according to claim 16, wherein the first antenna means is an X-axis antenna, and the second antenna means is a Y-Z axis antenna.

18. The key fob according to claim 16, wherein the first antenna means is a Y-axis antenna, and the second antenna means is a X-Z axis antenna.

19. The key fob according to claim 16, wherein the first antenna means is a Z-axis antenna, and the second antenna means is an X-Y axis antenna.

20. The key fob according to claim 16, wherein the second antenna means is a multiple inductive coil antenna.

21. The key fob according to claim 16, further comprising a second printed circuit board,
wherein the first antenna means is disposed on the printed circuit board, and
wherein the second antenna means is disposed on the second printed circuit board.

22. The key fob according to claim 16, further comprising:
diversity combining means for combining signals received from the first antenna means and the second antenna means, and for providing a combined reception signal as a result thereof.

23. The key fob according to claim 16, further comprising:
antenna characteristic changing means for changing the receive characteristics of the 2-D antenna based on strength of first and second signals respectively received by the 1-D and antenna and the 2-D antenna.
